(19) United States
(12) Patent Application Publication
(10) Pub. No.: US 2014/0129944 A1
(43) Pub. Date: May 8, 2014

(54) METHOD AND SYSTEM FOR SYNCHRONIZATION AND MANAGEMENT OF SYSTEM ACTIVITIES WITH LOCALLY INSTALLED APPLICATIONS

(71) Applicant: INTERNATIONAL BUSINESS MACHINES CORPORATION, Armonk, NY (US)

(72) Inventors: Kulvir Singh Bhogal, Fort Worth, TX (US); Gregory Jensen Boss, Saginaw, MI (US); Rick A. Hamilton, II, Charlottesville, VA (US); Anne R. Sand, Peyton, CO (US)

(73) Assignee: International Business Machines Corporation, Armonk, NY (US)

(21) Appl. No.: 13/668,786

(22) Filed: Nov. 5, 2012

(51) Int. Cl. G06F 3/01; G06F 15/16

(52) U.S. Cl. 715/730

(57) ABSTRACT

The present invention will enable an attendee/user to download a presentation from a host system location, synchronize the local user version of the presentation with the current location slide of the host presentation. In the present invention, an attendee/user can enter a command to the host system location of the presentation that will synchronize the local user version of the presentation with the current location of the host system presentation.

### CROSS-REFERENCE TO RELATED APPLICATIONS

This invention relates to applications serial numbers AUS920120043US1 and AUS920120044US1 the contents of which are incorporated by reference herein.

### FIELD OF THE INVENTION

This invention relates to a method and system for accessing and managing information located on a system by a remotely located machine device. In particular, the present invention relates to a method and system for synchronizing information located at a local machine location with information displayed at the host system location.

### BACKGROUND OF THE INVENTION

Slide presentations are a major form of communicating information to people. These presentations comprise information displayed on one or more slides with verbal communications based on the information displayed on the slides. Historically, these presentations have occurred in front of groups of people at one location. For example, a major component of many seminars and workshops is the slide presentation. The advancements in technology have provided new ways to use slide presentations to convey information to people. The Internet has initiated new ways tor people to communicate and exchange information.

One activity resulting from technology advancements has been web-conferencing. Web conferencing is a procedure that allows conferencing events to be shared with multiple remote locations. This procedure and format allows real-time point-to-point communications between parties. In addition, web-conferencing provides for multicast communications from one sender to many receivers. Web-conferencing technology also offers information of text-based messages, voice and video chat to be shared simultaneously, across geographically dispersed locations. Applications tor web conferencing include meetings, training events, lectures, or short presentations from any computer.

FIG. 1 illustrates a general configuration for a web-based conference or seminar. This process begins with the creation of a presentation that usually contains some audio and visual elements such as slides. The creator/presenter 100 uploads this presentation to a host provider location 102. This host provider can be a server device located on a network that is remote from the presenter and from those who will eventually view the presentation. Common names for this type of presentation in this format include web-conferencing and web-seminar (“webinar”). In implementation, the presenter 100 announces the activity and invites persons to attend. At the time of the activity, the presenter 100 accesses the presentation at the hosting provider 102. The attendees 104, 106, 108 and 110 also access the hosting provider to view the presentation. In the current webinar configuration, the presenter has access to and controls the presentation. The attendees access the hosting provider and view the presentation. The attendees have no control over the visual information presented. In some configurations, the attendees can ask questions of the presenter. When an attendee asks a question, the presenter can stop the presentation and answer the question. As shown in FIG. 1, the presenter 100 has the ability to transmit to and receive information from the hosting provider 102. However, as also shown, the attendees can only access and view information from the hosting provider.

During a webinar, the attendees can view the slides from the hosting provider. In another arrangement, the attendees can. download the presentation to their local machine and view the presentation as it is occurring. However, in some instances, attendees may join a presentation after the start of the presentation. When this occurs, some attendees do not know the current slide of the presentation. The attendee can spend substantial time trying to locate the current location slide of the presentation. In other situation, when an attendee/user has downloaded the presentation and it controlling it at the user local machine, the user may temporarily leave the presentation. As a result, the user will lose the current location of the presentation.

Although the present inventors of this application are designing technology that will enable an attendee to download an entire presentation (including slides not yet discussed) and synchronize the presentation at the time of the download, there remains a need for a method and system to enable an attendee/user to synchronize the user's local downloaded version with the current slide being displayed during the presentation.

### SUMMARY OF THE INVENTION

The present invention enables an attendee/user to download a presentation from a host system location, synchronize the local user version of the presentation with the current location slide of the host presentation. In the present invention, an attendee/user can enter a command to the host system location of the presentation that will synchronize the local user version of the presentation with the current location of the host system presentation. In this method, after issuance of the synchronization command, present invention would identify the current side being displayed at the host system location. The method of the present invention would then perform a search of the slides in the version of the presentation at the user's local machine. When a slide match occurs between the identified host presentation slide and a slide from the user/attendee local presentation version, the present invention would synchronize the slide of the user local presentation version with the identified current slide of the host presentation.

### DESCRIPTION OF THE DRAWINGS

FIG. 1 is a view of a configuration of a conventional web-conferencing event.

FIG. 2 is a view of a configuration of a web-conferencing event in which an attendee views the displayed information while the information is being downloaded to the attendee's local machine.

FIG. 3 is a view of a configuration, of a web-conferencing event in which an attendee views the displayed information on the attendee's local machine.

FIG. 4 is a view of a configuration of a web-conferencing event in which an attendee views the displayed information on the attendee's local machine, while accessing presentation audio from another device.

FIG. 5 is a view of the components of a web-hosting provider.

FIG. 6 is a general flow diagram of the steps in viewing an online presentation.

FIG. 7 is a flow diagram of the steps in the implementation of the method of the present invention.

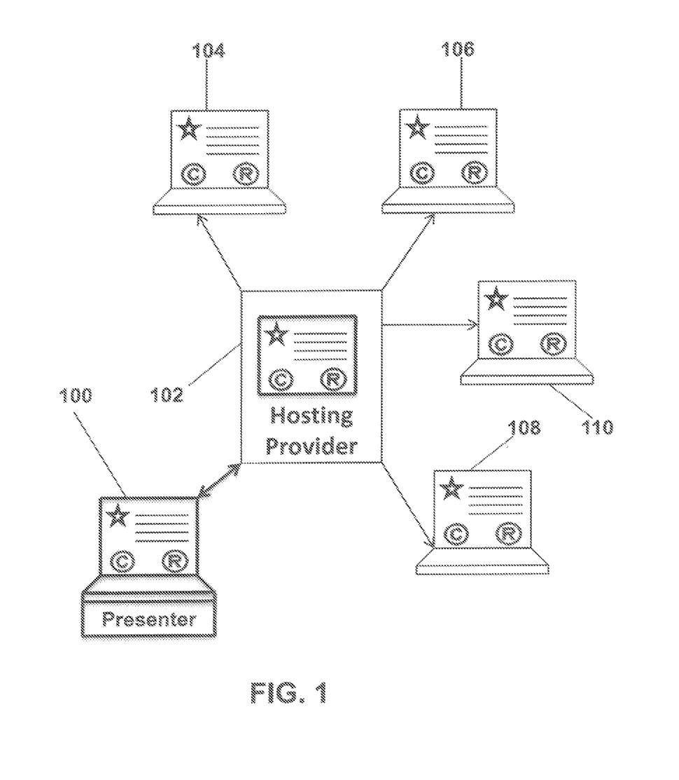

### DETAILED DESCRIPTION OF THE INVENTION

This system of the present invention will enable the user to follow a presentation while waiting for presentation files to download to the user's local machine. This invention provides a dynamic cloud based approach to local hand-off. It will enable users to view a cloud or other remotely-based (found via a URL) or screen-shared version of the presentation until a designated threshold portion of the source material has downloaded. After the downloading of the designated threshold portion of the material has occurred, the user will be able to view at the local machine of the user, the presentation while the remainder of the presentation continues to download.

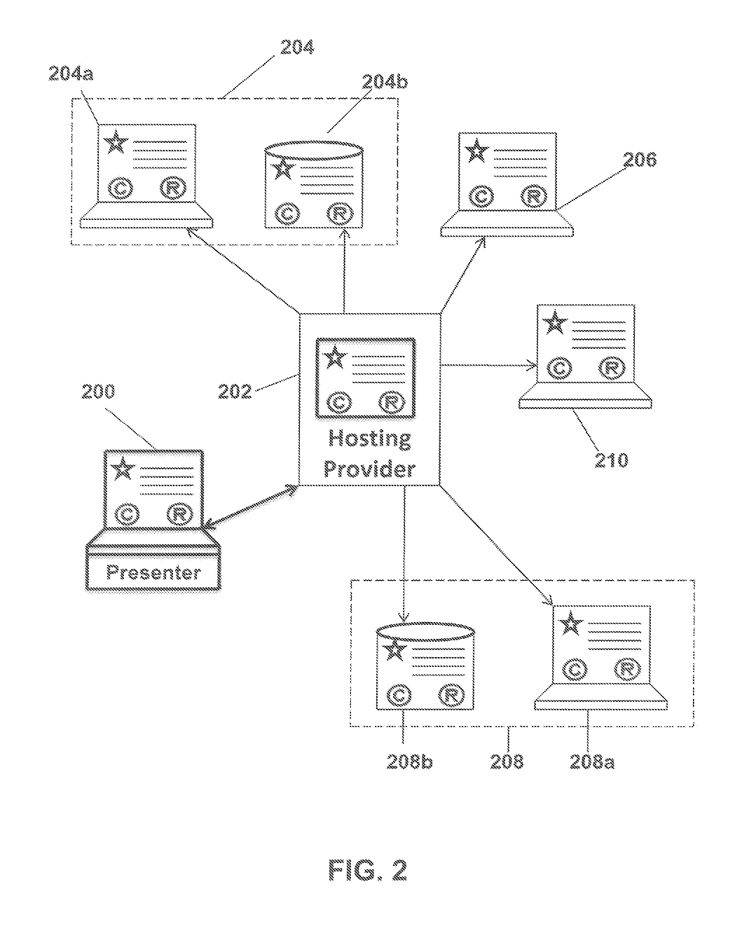

Referring to FIG. 2, shown is a configuration of the system of the present invention in which a presenter 200 is in communication with the hosting provider 202 and begins to conduct a presentation. As mentioned, the presenter has the ability to remotely control the presentation at the hosting provider 202. The user attendees connect to the hosting provider to access the presentation. In this configuration, two of the attendees (206 and 210) are viewing the presentation in a conventional manner. Attendees (204 and 208) are viewing the presentation by implementing the method and system of the present invention. As shown, attendee 204 comprises a computing device 204a and a memory device 2114b. The same shows for attendee 208. Both the computing device 204a, 208a and the memory device 204b, 208b are directly connected to the hosting provider 202. At fee initiation of the presentation, the presentation content is being viewed on the computing device 204a while it is also being stored on the memory device 204b. Once the download of the contents is complete, the present invention will synchronize the downloaded presentation with the current location of the presentation at the hosting provider. This synchronizing action is part of the formal hand-off of the presentation from the hosting provider to the local user. At this point, the user can begin viewing the presentation contents from the presentation file stored in the memory device 204b.

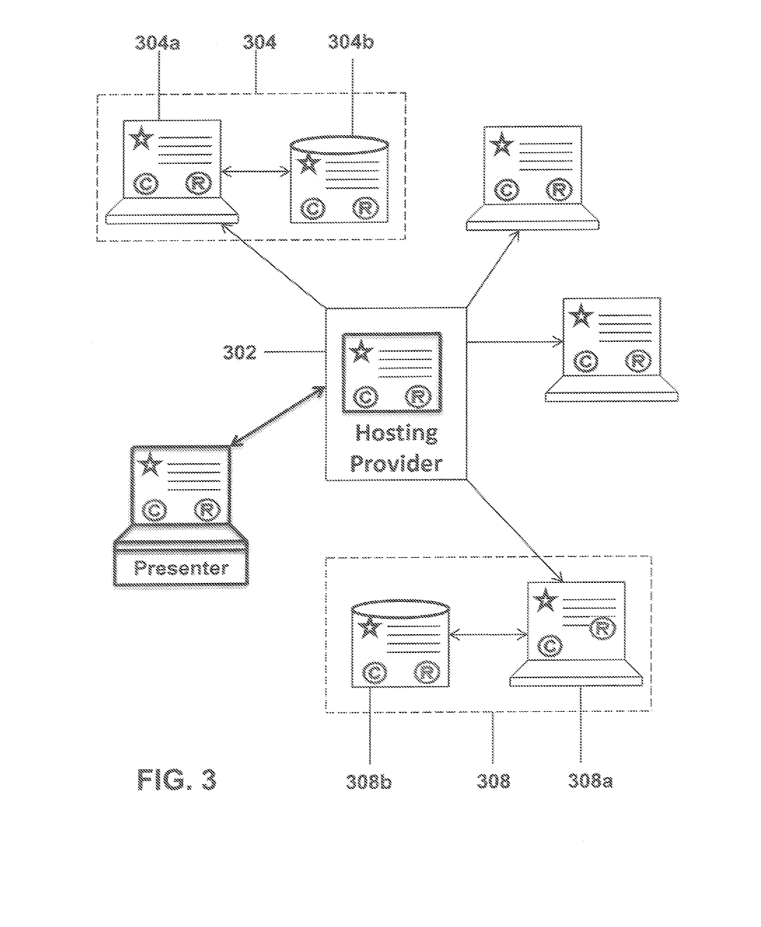

FIG. 3 shows a configuration of the present invention wherein an attendee 304 is viewing a downloaded presentation file of the presentation stored in the memory device 304b from the computing device 304a. The computing device 304a is in communication with the memory device 304b and with the hosting provider 302. The user will view the presentation file stored on the memory device on the computing device. The user will listen to the audio of the presentation directly from the hosting provider.

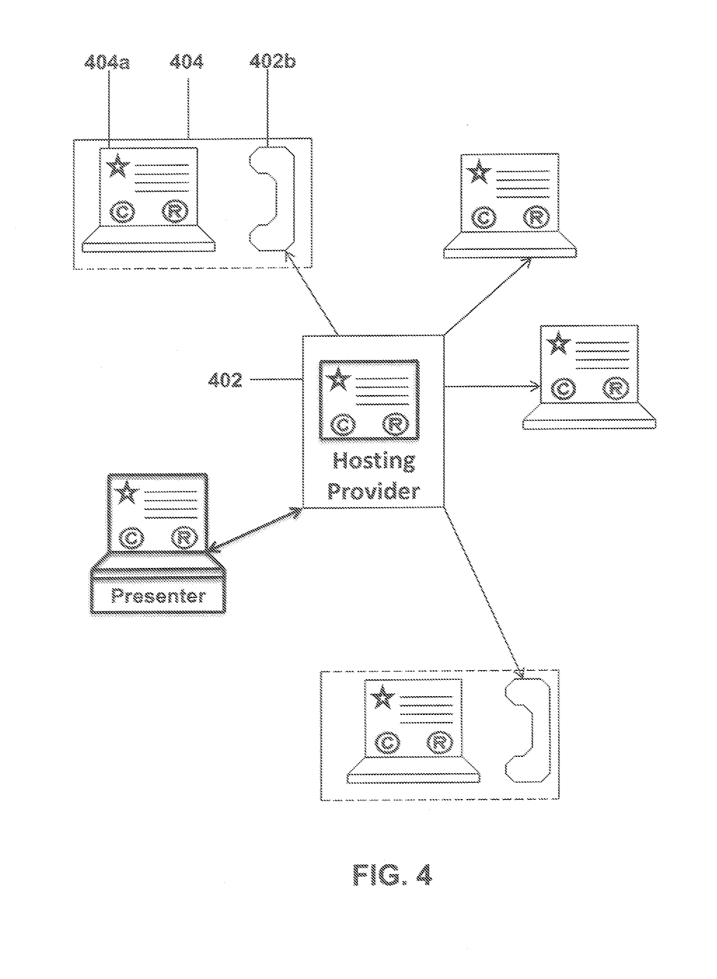

In most configurations, the memory device and the computing device are the same physical device. Further, when viewing many of these online/webinar presentations, the user is located at some stationary location. However, with the active lives of many individuals, there can be situations when a user does not have time to sit at one location and view an entire presentation. FIG. 4 is a configuration wherein a user can view a presentation while traveling. The user 404 will initially download the presentation file from the hosting provider 402 to a local storage location. In this configuration, the local storage device is in the computing device 404a. As mentioned, once the presentation file is downloaded to the local memory/machine 404a, the presentation is automatically synchronized to the currently slide location of the presentation. The user can incorporate a second electronic device to access the hosting provider 402. The second user device can be any device that will enable access to the audio portion of the presentation. Once the user has established an audio connection to the hosting provider 402, the user can listen to the presentation while viewing the presentation information. For example, with this configuration, a user can view a real-time presentation while riding a motor vehicle.

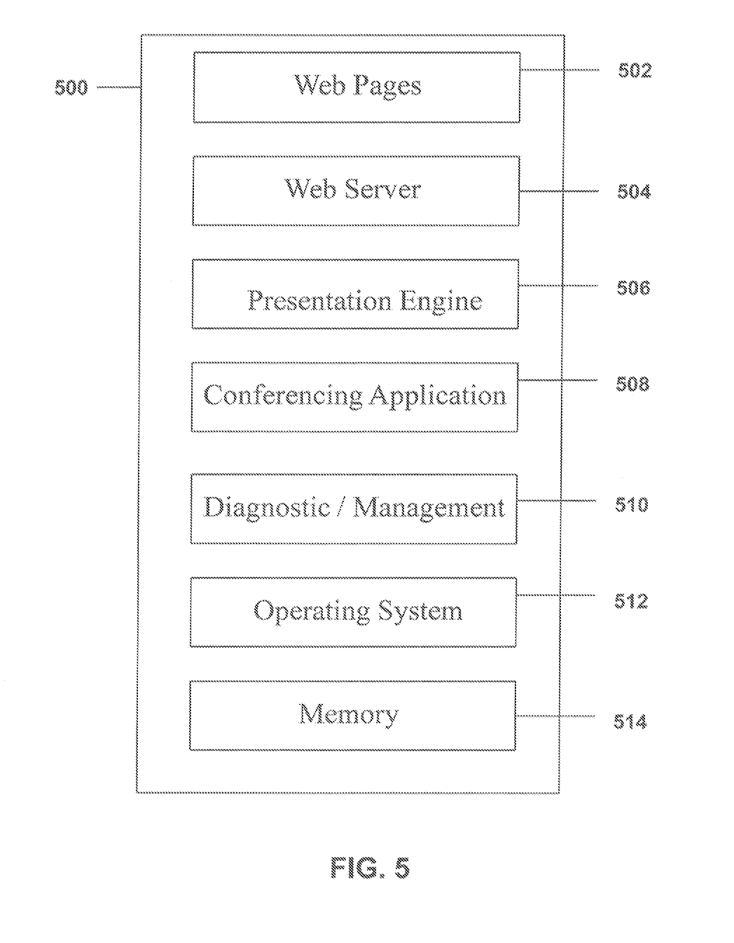

FIG. 5 illustrates basic components of the hosting provider device. As mentioned, the hosting provider can be a server machine located on a communication network. Presenters would upload their presentations to the hosting provider. Users would access the hosting provider to view the presentations and download presentations to local user machines. The hosting provider 500 can also be a configuration of components that form a hosting system. As illustrated, this hosting provider 500 can comprise a series of web pages 502 and a web server 504. A presentation engine 506 and conferencing applications 508 are the main components to facilitate the presentation options and functions of the present invention. The diagnostic and management module 510 ensures that the hosting provider continues to properly function. The operating system 512 and the memory 514 are basic components of any computing system.

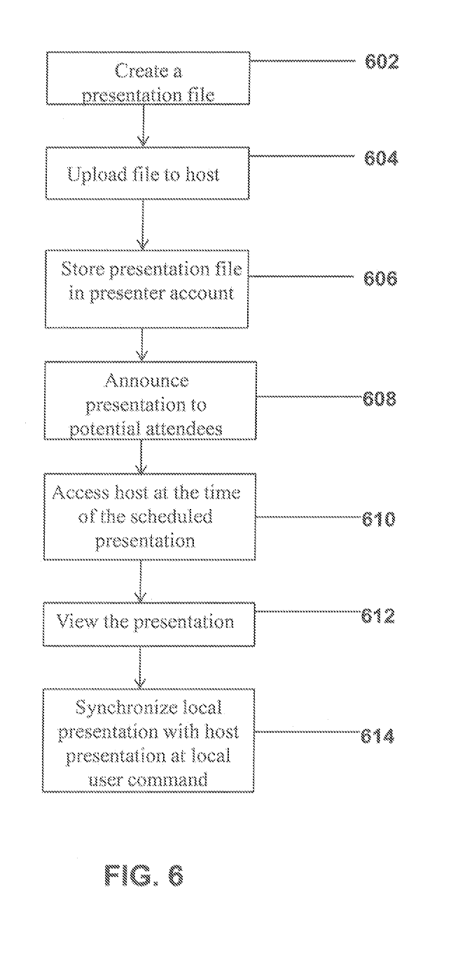

The present invention comprises a system and a method for synchronization and management of system activities with locally installed applications. FIG. 6 illustrates a flow diagram of the general steps in creating a presentation and viewing the presentation from the hosting provider. In step 602, a presenter prepares a presentation and creates a presentation file. This presentation file could be a PowerPoint type file with multiple slides containing presentation information. After completion of the creation of the presentation file, the presenter uploads the presentation file to the host provider in step 604. The host stores the presentation file in ail account for that particular presenter. This file storage activity occurs in step 606. Before the actual presentation, in step 608 announcement of the presentation is sent out to potential attendees. The presentation announcement contains information about the presentation topic, presentation, time and presentation access information. At the time of the presentation, the presenter and attendees who chose to view the presentation will access the hosting provider in step 610. In step 612, the presentation begins with the presenter in control and presenting the information to the attendees. The attendees access the presentation and view the presentation from their local computing machines.

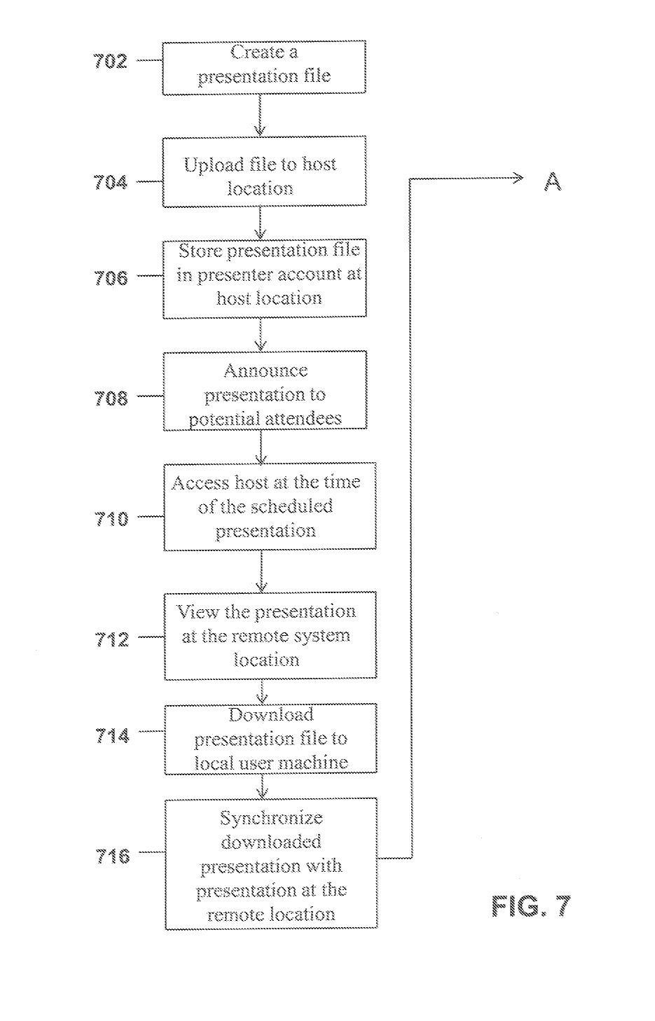

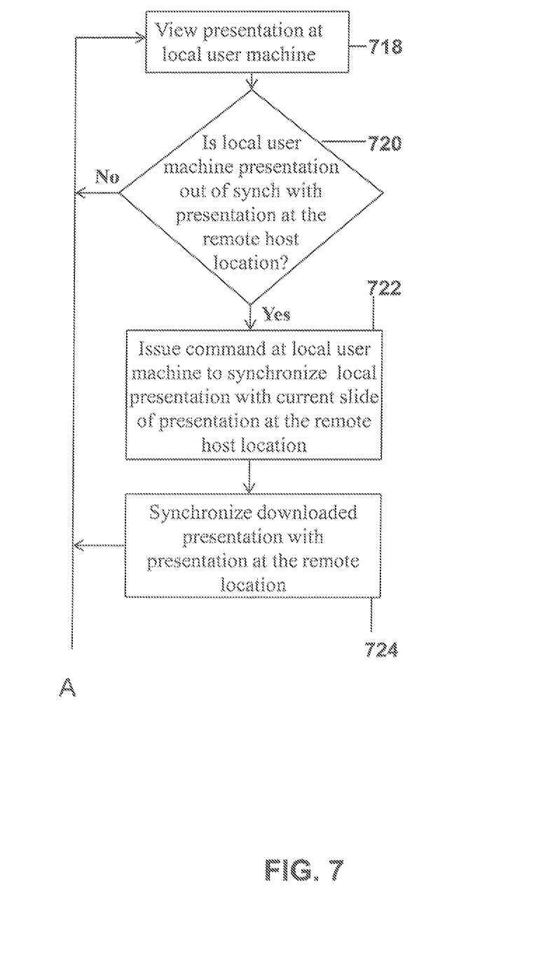

FIG. 7 is a flow diagram of the steps in the implementation of the method of the present invention. This method illustrates the downloading of a presentation file to an attendee's local machine while enabling the attendee to continuously view the presentation at the hosting provider during the downloading process. The steps in FIG. 7 continue the process from the end of the method of FIG. 6

Referring to FIG. 7, in the initial step 702, a presentation presenter at a host system location creates a presentation file. As part of this presentation file creation, each file slide of the presentation file can have a unique identifier such as a number, letter or symbol for each file. After creation of the presentation file, in step 704, the presenter uploads the presentation file to the system host machine. After the presentation file upload, step 706 stores the uploaded presentation file in an account of the presenter. At this point, step 708 announces and advertises the presentation to potential attendees. This announcement can include the time of the presentation and information that will enable an attendee to access the presentation.

At the scheduled time of the presentation, in step 710, attendees access the host system location where the presentation file slides will initially be displayed. In step 712, the attendee begins to view the slide presentation at the host system location. After the start of the presentation, step 714 enables an attendee to download the slide presentation to the attendee's local viewing device/machine. As part of the download, step 716 synchronizes the presentation version downloaded to the attendee's local machine with the current location of the presentation at the system host location 402. Once the presentation is downloaded and synchronized at the attendee's local machine, the attendee can begin viewing the presentation through the attendee's local machine.

In step 718, the attendee continues to view the presentation from the attendee's local machine. In this form of presentation, the attendee may have work advance the presentation from the attendee's local machine. There may be some type of prompt to inform the attendee when it is time to move to the next slide in the presentation. Step 720 can be an optional step that monitors the current slide of host presentation that is being displayed. This step 720 can detect when the attendee's local machine version of the presentation is out of synch with the host presentation. If the determination in step 720 is that the presentation version at the attendee's local machine is in synch with the host presentation, then the method continues in monitor mode at step 720. If the determination in step 720 is that the attendee's local version of the presentation is out of synch with the host presentation, then the method moves to step 722 which issues a command from the local attendee machine to synchronize the local presentation with the current slide of the presentation at the host location.

As previously mentioned, an attendee can also detect that the local attendee presentation is out of synch with the host presentation. For example, if the attendee is interrupted for some reason during the presentation and does not advance the slide on prompt, the attendee presentation can get out of synch with the host presentation version. When this occurs, as part of the method of the present invention, the attendee can also issue a synchronization command at step 722.

Step 724 performs synchronization of the attendee's local machine presentation version with the host presentation version. As part of this step, each slide of the host presentation could have a unique identifier. This unique identifier would also be present on the corresponding slide of the downloaded attendee presentation. In the synchronization process, in response to the synchronization command at the attendee's local machine, a query could be sent to the host location to retrieve the identity of the current slide being displayed. After retrieval of this identifier, the slide of the attendee's downloaded version is retrieved and displayed on the attendee's local machine. At this point, the host presentation and attendee local presentation should be synchronized. Attendee could then continue viewing the presentation from the current slide location.

This invention enables an attendee to quickly identify the location of a presentation that is currently in process without the need to spend substantial time and effort trying to identify the current location of the presentation.

It is important to note that while the present invention has been described in the context of a fully functioning data processing system, those skilled in the art will appreciate that the processes of the present invention are capable of being distributed in the form of instructions in a computer readable storage medium and a variety of other forms, regardless of the particular type of medium used to carry out the distribution. Examples of computer readable storage media include media such as EPROM, ROM, tape, paper, floppy disc, hard disk drive, RAM, and CD-ROMs.

We claim:

1. A method for synchronizing a presentation file of a system host provider at a remote system location with a corresponding version of the presentation file of the system host provider at a local user computing machine comprising:
accessing system host provider downloadable presentation files for viewing by a user, then accessing a desired downloadable presentation file and then beginning viewing of the desired downloadable presentation file contained at the system host provider;
determining whether a user viewing a presentation file contained at a system host provider desires to view the presentation files at a user local machine;
when the determination is that the user desires to view the presentation file at the local user computing machine, initiating a file download process from the system host provider to the user local machine while continuing to view the presentation file at the system host provider;
transferring user access from the presentation file being shown at the system host provider to access of the downloaded presentation file at the local user machine;
opening the downloaded presentation file at the user local machine at a current location that matches a location of the presentation file being shown at the system host provider;
detecting an out of synchronized downloaded presentation file at the user local machine;
issuing a command to synchronize the downloaded presentation file at the user local machine with the presentation file being shown at the system host provider; and
synchronizing the downloaded presentation file at the user local machine with the current a current location of the system host provider file presentation.

2. The method as described in claim 1 wherein the presentation file can comprise a series of slides capable of being displayed at the system host provider at a remote system location and at the local user machine.

3. The method as described in claim 1 wherein said presentation file download process further comprises creating and attaching to each slide in said presentation file an identifier that is unique to that slide.

4. The method as described in claim 3 wherein each slide of a presentation file downloaded from the system host provider at a remote system location to a local user machine has the same unique identifier for each corresponding downloaded slide at the local user machine.

5. The method as described in claim 4 wherein said detecting step further comprises:
monitoring a slide presentation at the local user machine; and
automatically detecting an out of synch presentation at the local user machine.

6. The method as described in claim 5 wherein a synchronization command is automatically issued by the local user machine to the system host provider at a remote system location.

7. The method as described in claim 4 wherein said detecting step further comprises:
monitoring a slide presentation at the local user machine; and
detecting an out of synch presentation at the local user machine by a user viewing the presentation.

8. The method as described in claim 7 wherein said detecting an out of synch presentation at the local user machine further comprises identifying a current slide being displayed at the system host provider and comparing the current slide at the system host provider with the current slide being displayed at the local user machine.

9. The method as described in claim 7 wherein a synchronization command is issued by the user at the local user machine to the system host provider at a remote system location.

10. The method as described in claim 4 wherein said synchronization of the downloaded presentation file at the local user location comprises:
identifying the current slide being displayed at the system host provider
identifying a corresponding slide at the local user machine; and
adjusting the downloaded presentation at the local user machine to display at the local user machine the corresponding slide to the currently identified slide being displayed at the system host provider.

11. The method as described in claim 1 wherein said opening the downloaded presentation file at the user local machine at a current location further comprises opening the presentation file at the local user machine while the presentation file is downloading from the system host provider to the local user machine.

12. A computer program product stored in a computer readable storage medium for synchronizing a presentation file of a system host provider at a remote system location with a corresponding version of the presentation file of the system host provider at a local user computing machine comprising:
instructions accessing system host provider downloadable presentation files for viewing by a user;
instructions determining whether a user viewing a presentation file contained at a system host provider desires to view the presentation files at a user local machine;
when the determination is that the user desires to view the presentation file at the local user computing machine, instructions initiating a file download process from the system host provider to the user local machine while continuing to view the presentation file at the system host provider;
instructions transferring user access from the presentation file being shown at the system host provider to access of the downloaded presentation file at the local user machine;
instructions opening the downloaded presentation file at the user local machine at a current location that matches a location of the presentation file being shown at the system host provider;
instructions detecting an out of synchronized downloaded presentation file at the user local machine;
instructions issuing a command to synchronize the downloaded presentation file at the user local machine with the presentation file being shown at the system host provider; and
instructions synchronizing the downloaded presentation file at the user local machine with the current a current location of the system host provider file presentation.

13. The computer program product as described in claim 12 wherein said detecting instructions further comprise:
instructions monitoring a slide presentation at the local user machine; and
instructions automatically detecting an out of synch presentation at the local user machine.

14. The computer program product as described in claim 13 wherein a synchronization command instruction is automatically issued by the local user machine to the system host provider at a remote system location.

15. The computer program product as described in claim 12 wherein said synchronization of the downloaded presentation file at the local user location comprises:
instructions identifying the current slide being displayed at the system host provider
instructions identifying a corresponding slide at the local user machine; and
instructions adjusting the downloaded presentation at the local user machine to display at the local user machine the corresponding slide to the currently identified slide being displayed at the system host provider.

16. A system for synchronizing a presentation file of a system host provider at a remote system location with a corresponding version of the presentation file of the system host provider at a local user computing machine comprising:
a system host provider at a remote system location, said host provider capable of storing and displaying presentation files and capable of downloading presentation files to local user computing machines;
a plurality of local user computing machines capable of receiving and displaying slides from a presentation file;
a presentation file containing one or more displayable and viewable slides;
a communication system for enabling said plurality of local user machines to communicate with said system host provider; and
a plurality of presentation file management modules, one of each said plurality of
presentation file management modules being located in each of said plurality of local user computing machines.

17. The system as described in claim 16 wherein said presentation file management module has the capability to detect the synchronization of slides in a presentation file at said system host provider and a corresponding file, to the presentation file at the system host provider file, downloaded at the local user machine.

18. The system as described in claim 17 wherein said presentation file management module has the capability to adjust a presentation file at the local user machine so that a current slide being displayed at the local user machine is the same a corresponding slide currently being displayed at the system host provider.
